(19) United States
(12) Patent Application Publication
(10) Pub. No.: US 2026/0141321 A1
(43) Pub. Date: May 21, 2026

(54) USERS WORKLOAD TECHNIQUE IMPLEMENTED TO REDUCE STRESS

(71) Applicant: INTERNATIONAL BUSINESS MACHINES CORPORATION, ARMONK, NY (US)

(72) Inventors: HUMBERTO OROZCO CERVANTES, TONALÁ (MX); JAVIER ALBERTO BECERRA BERMUDEZ, TLAQUEPAQUE (MX); JORGE ADRIAN MENESES BARRAGAN, TLAQUEPAQUE (MX); RUBEN EDGAR AGUIRRE CASTRO, TLAQUEPAQUE (MX)

(21) Appl. No.: 18/949,653

(22) Filed: Nov. 15, 2024

(51) Int. Cl. G06Q 10/0631

(52) U.S. Cl. CPC G06Q 10/063112

(57) ABSTRACT

A method, computer system, and a computer program product are provided for managing occupational workload. Information is obtained about an occupational workload that includes one or more tasks. The features of the occupational workload including the tasks are extracted. A task performer is assigned to each task. A stress level is calculated for each task performer assigned to each task. The stress level is compared against a preselected value. An alert is generated when the calculated level exceeds the preselected value. The occupational workload is rebalanced when any alert is generated. The rebalancing can include at least one of reassigning a new task performer to one or more tasks, increasing a time allocated for completing each task or increasing number of task performers allocated to complete each task.

### BACKGROUND

The present invention relates generally to data and workload management and more particularly to techniques for evaluating user workload and implementing digital solutions to reduce stress.

Occupational stress has become a concern for both employees and employers. Occupational stress can affect productivity, quality of product and services, job conditions, and employees'emotional well-being, physical health, and job performance. Several models have been developed in recent years that research and gather statistical data to measure occupational stress.

The purpose of these models are to identify and develop mechanisms that can reduce or eradicate conditions that cause stress levels. These mechanisms can be developed to benefit the work environment in short, medium or long-term depending on the conditions that cause these stress levels and based on suitability for the staff and job performance.

In addition, artificial intelligence (AI) and related algorithms can be used to predict for complex and unexpected events that can impact stress causing issues.

### SUMMARY

Embodiments of the present invention disclose a method, computer system, and a computer program product for managing occupational workload. Information is obtained about an occupational workload that includes one or more tasks. The features of the occupational workload including the tasks are extracted. A task performer is assigned to each task. A stress level is calculated for each task performer assigned to each task. The stress level is compared against a preselected value. An alert is generated when the calculated level exceeds the preselected value. The occupational workload is rebalanced when any alert is generated. The rebalancing can include at least one of reassigning a new task performer to one or more tasks, increasing a time allocated for completing each task or increasing number of task performers allocated to complete each task.

### BRIEF DESCRIPTION OF THE SEVERAL VIEWS OF THE DRAWINGS

These and other objects, features and advantages of the present invention will become apparent from the following detailed description of illustrative embodiments thereof, which may be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for occupational workload management, according to an embodiment; and

FIG. 3 provides a flowchart diagram illustration of an alternate embodiment

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

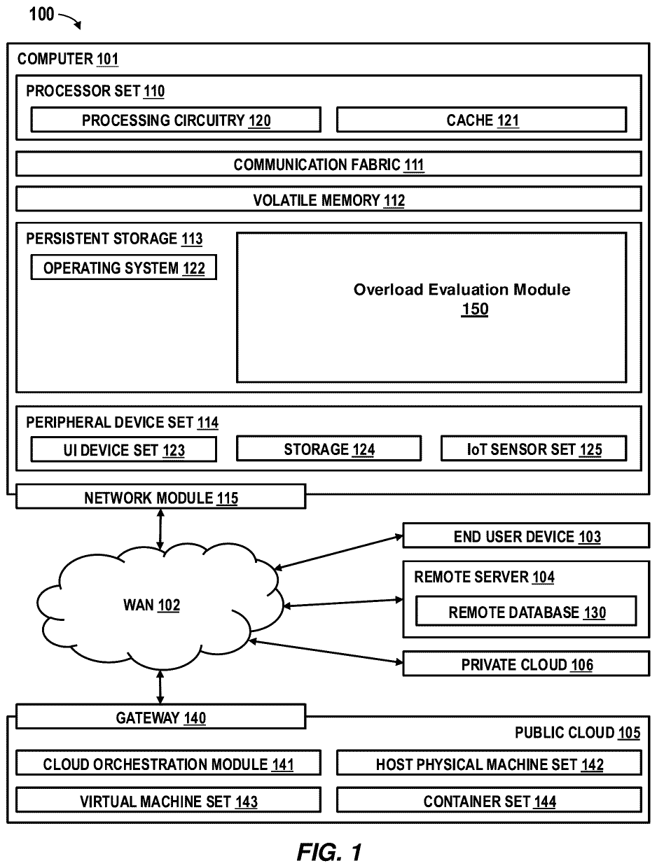

FIG. 1 provides a block diagram of a computing environment 100. The computing environment 100 contains an example of an environment for the execution of at least some of the computer code involved in performing the inventive methods, such as code change differentiator which is capable of providing work overload evaluation module (150). In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

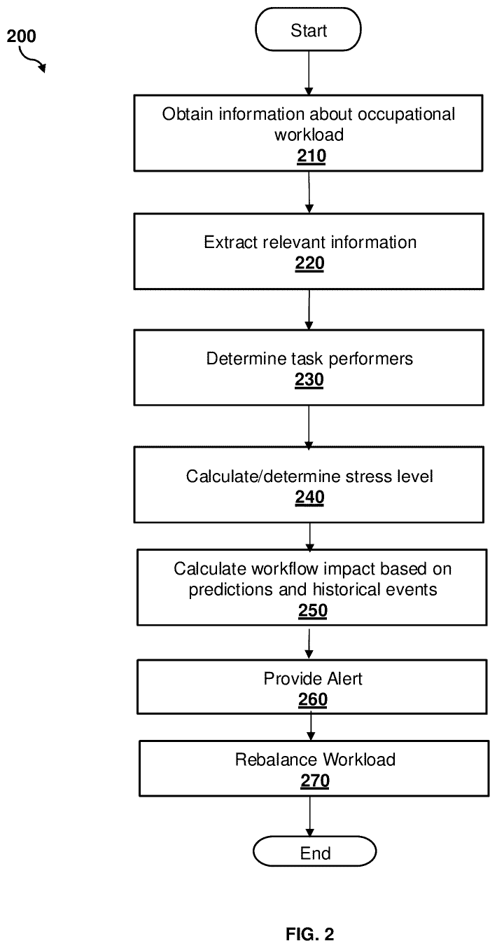

The impact of occupational stress has increased in recent years. The impact of occupational stress on productivity and employee health is important to the companies. FIG. 2 provides a process 200 that presents a mechanism to eradicate or reduce stress levels in a variety of workplaces that result in more work inducing environments.

In Step 210, process 200, obtains information about a particular occupational workload. In one embodiment, the workload may be include one or more tasks to be completed.

In Step 220, a variety of information is then extracted relating to the obtained workload. This can include, the number of people (employees) engaged in performing the role and their specific job titles and amount of time that is planned to be attributable to each role. The extraction can also include similar information for completion of one or more tasks that are related to workload completion.

In Step 230, a task performer (employee, user etc.) is then selected. The selection may have been performed by management or other sources. Alternatively, when no performer is selected, one or more resources/sources can be reviewed to select one or more performers for one or more each tasks or for the entirety of the workload.

In Step 240, a stress level is identified based on the number of hours and type of user role. In one embodiment, an Artificial Intelligence (AI) can be used and machine and workflow modeling can be used with statistical data to determine workflow management and employee information.

In Step 250, workflow can be analyzed to make predictions for completing the task. In one embodiment, historical data of can be obtained based on possible previous issues that had impacted workload completion.

In Step 260, in one embodiment, a user profile is analyzed for each person that is contributing to completion of the workload (task or workload performers). In one embodiment, the user profile can include, the employee availability, skill level, disability and other pertinent and available data.

In Step 270, the method using an AI, in one embodiment, can analyze the tolerance of the employee/user to a particular workload situation that will ensue stress. This can then be combined with event prediction, including a possibility of unexpected events (based on the previous historical events) to determine the possibility to issues arising that may impact the employee/user. This analysis will include stress levels expected relating to different situations as well as task complexity. In one embodiment, the process can provide an alerting system, that can be provided to an employee/user or a workflow manager. The alerting system can be based on a threshold of a preselected set of parameters that were measured during the analysis.

When there is an alert or alternatively, when AI determines that a work rebalance needs to be conducted, optionally the AI can then readjust the workflow as shown in Step 270. This may comprise selecting different employee/performers, extending the time allocated to complete the workload/task or involving additional resources (AI etc,) to reduce the impact of the original user/employee. In addition, the original performer/employee can be provided biometric devices or other digital tools to measure the stress level. The latter may be also monitored and certain conditions (blood pressure and heart rate) can provide an alert to the user/employee, a workload manager or health individuals to address the occupational stress and reduce it.

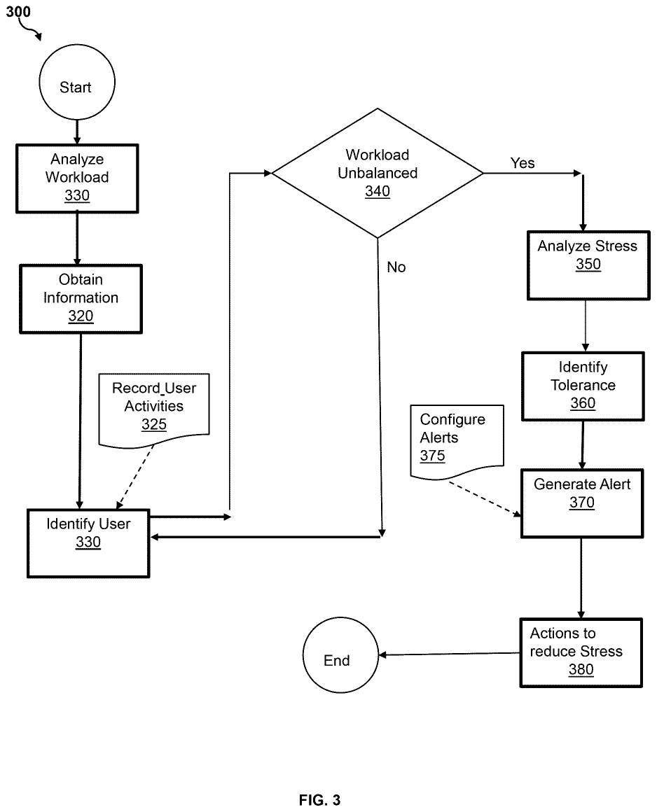

FIG. 3 provides for an alternate flowchart showing another process 300 similar to that of process 200. In Step 310, a variety of models are considered for analyzing a particular workload activity. When AI is used these could be machine language models. More than one model may be used depending on the particular needs of the workload activities.

In Step 320, similar to what was discussed in Step 210, information about the workload is obtained. This could be general information and/or information needed for using a specific model (machine language model etc.).

In Step 330, a particular user can be identified, or a role can be identified and a user be selected based on user skill. In one embodiment, user role may be selected or identified relating to a particular workload or task completion. Information relating to the user and user activities may also be obtained or selected using one or more recording of user activities or tools available or previously used by the user (Github, Jira, etc.) as seen at Step 325. Similar information may also be obtained from a variety of other sources associated with the user and/or the role and its task related activities. This is illustrated by Step 315.

In Step 340, an AI (machine language models) or similar methodology can be used to analyze a given workload and its related activities. The information provided in Steps 310 to 330 can then be analyzed (such as by one or more by the machine language models) to make an assessment as to whether the workload is balanced and acceptable as with regards to the resources (employee/performer skills, time availability, number of users assigned to the task etc.). This will then render a decision as whether the workload is balanced or unbalanced (Yes or No paths from decision block of Step 340).

When the workload is balanced (No pathways), the process is returned back to Step 310 and reiterated and it is continued until at a point where is deemed unbalanced. When and at any point that the process is deemed unbalanced (path Yes—could be dependent on tasks complexity as well), the process then implements techniques to analyze stress situations based on task complexity as shown at Step 350.

The implementation of techniques to reduce stress, may in one embodiment involve identifying stress tolerance based on a user profile, as shown at Step 360. As was discussed in FIG. 2, this can also involve predicting actions that mitigate the user's stress situation.

As previously, discussed, according to one embodiment, an alert system can be created as shown at Step 370 when a stressful situation is identified. The presence of a stressful situation can be identified in a variety of manners as known by those skilled in the art. Some examples can be through sensors, cameras and devices that monitor biometric data, or through AI devices or through software and modeling. Alerts can depend on exceeding or falling below some thresholds of certain parameters and can be configurable for stressful situations to prevent health issues (shown at Step 375). In Step 380, actions can be further implemented to address these stress related issues.

Process 200 and 300 together provide techniques for managing occupational workload. Information is obtained about completion of an occupational workload and the occupational workload includes one or more tasks. Features of the tasks and/or the occupational workload is extracted. Task performers are assigned to each of the tasks. A stress level is calculated for each task performer while completing the tasks assigned and an alert system is generated when stress level exceeds a particular value. The workload is then rebalanced once an alert is generated. The rebalancing can include reassigning task performers, increasing a time allocated for completing each task or increasing number of task performers allocated to each task. In one embodiment, at least one task performer is assigned to each of the one or more tasks prior to selecting task performers. In one embodiment, an artificial intelligence (AI) engine using one or more machine learning model is used. In one embodiment, at least one or more stress reducing models can be used, such as AI machine language models, prior to workload rebalancing. The AI can also predict any future event that is going to impact stress levels and rebalancing workload and task performance criteria accordingly. The task performer is selected based on said task performer's skills and/or said task performer's availability, number of task performers needed to complete each task and a time assigned to complete the workload. They may be selected from a list generated based on a plurality of available task performers and their corresponding skill and availability. The task performer's may be determined by obtaining information about previous task performers'similar tasks completed through one or more sources.

The descriptions of the various embodiments of the present invention have been presented for purposes of illustration but may not be intended be limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing occupational workload, comprising:
obtaining information about an occupational workload, wherein said occupational workload includes one or more tasks;
extracting features of said occupational workload including said one or more tasks;
assigning a task performer to each of said one or more tasks;
calculating a stress level for said task performer assigned to said one or more tasks assigned;
comparing said calculated stress level against one or more preselected values;
generating an alert when said stress level calculated exceeds said one or more preselected values; and
rebalancing said occupational workload when any alert is generated, wherein rebalancing can include at least one of reassigning a new task performer to one or more tasks, increasing a time allocated for completing each task or increasing number of task performers allocated to complete each task.

2. The method of claim 1, further comprising monitoring any task performer during performance of said one or more tasks assigned and continuously recalculating said stress level during performance of said one or more tasks.

3. The method of claim 1, wherein an artificial intelligence (AI) engine using one or more machine learning model is used.

4. The method of claim 3, further comprising allocating at least one or more stress reducing models prior to workload rebalancing.

5. The method of claim 3, further comprising predicting any future event that is going to impact stress levels and rebalancing workload and task performance criteria accordingly.

6. The method of claim 2, wherein said task performer is selected based on said task performer's skills and/or said task performer's availability, number of task performers needed to complete each task and a time assigned to complete said workload.

7. The method of claim 1, wherein said task performers are selected from a list generated based on a plurality of available task performers and their corresponding skill and availability.

8. The method of claim 7, wherein said task performers'skill has been determined by obtaining information about previous task performers'similar tasks completed through one or more sources.

9. A computer system for managing occupational workload, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps:
obtaining information about an occupational workload, wherein said occupational workload includes one or more tasks;
extracting features of said occupational workload including said one or more tasks;
assigning a task performer to each of said one or more tasks;
calculating a stress level for said task performer during performance of said one or more tasks assigned;
comparing said calculated stress level against one or more preselected values;
generating an alert when said stress level calculated exceeds said one or more preselected values; and
rebalancing said occupational workload when any alert is generated, wherein rebalancing can include at least one of reassigning a new task performer to one or more tasks, increasing a time allocated for completing each task or increasing number of task performers allocated to complete each task.

10. The computer system of claim 9, further comprising further comprising monitoring any task performer during performance of said one or more tasks assigned and continuously recalculating said stress level during performance of said one or more tasks.

11. The computer system of claim 9, wherein an artificial intelligence (AI) engine using one or more machine learning model is used.

12. The computer system of claim 11, further comprising allocating at least one or more stress reducing models prior to workload rebalancing.

13. The computer system of claim 11, further comprising predicting any future event that is going to impact stress levels and rebalancing workload and task performance criteria accordingly.

14. The computer system of claim 10, wherein said task performer is selected based on said task performer's skills and/or said task performer's availability, number of task performers needed to complete each task and a time assigned to complete said workload.

15. The computer system of claim 9, wherein said task performers are selected from a list generated based on a plurality of available task performers and their corresponding skill and availability.

16. The computer system of claim 15, wherein said task performers'skill has been determined by obtaining information about previous task performers'similar tasks completed through one or more sources.

17. A computer program product for managing occupational workload, comprising:
one or more computer-readable storage media; and
program instructions stored on said one or more computer-readable storage media, comprising:
obtaining information about an occupational workload, wherein said occupational workload includes one or more tasks;
extracting features of said occupational workload including said one or more tasks;
assigning a task performer to each of said one or more tasks;
calculating a stress level for said task performer during performance of said one or more tasks assigned;
comparing said calculated stress level against one or more preselected values;
generating an alert when said stress level calculated exceeds said one or more preselected values; and
rebalancing said occupational workload when any alert is generated, wherein rebalancing can include at least one of reassigning a new task performer to one or more tasks, increasing a time allocated for completing each task or increasing number of task performers allocated to complete each task.

18. The computer program product system of claim 17, further comprising further comprising monitoring any task performer during performance of said one or more tasks assigned and continuously recalculating said stress level during performance of said one or more tasks.

19. The computer program product system of claim 17, wherein an artificial intelligence (AI) engine using one or more machine learning model is used.

20. The computer program product system of claim 19, further comprising allocating at least one or more stress reducing models prior to workload rebalancing.
